(19) United States
(12) Patent Application Publication
(10) Pub. No.: US 2025/0342249 A1
(43) Pub. Date: Nov. 6, 2025

(54) TECHNIQUES FOR DETECTING MALICIOUS SOFTWARE IN A COMPUTING ASSET

(71) Applicant: IntSights Cyber Intelligence Ltd., Tel Aviv-Yafo (IL)

(72) Inventors: Natalie Zargarov, Tel Aviv-Yafo (IL); Erez Breiman, Tel-Aviv (IL); Denis Kamanovsky, Ram At-Gan (IL); Eduard Bobritsky, Yahud-Monosson (IL)

(21) Appl. No.: 19/039,321

(22) Filed: Jan. 28, 2025

(30) Foreign Application Priority Data
May 2, 2024 (IL) 312543

(51) Int. Cl. G06F 21/56; G06F 9/30

(52) U.S. Cl. CPC G06F 21/56; G06F 9/3009

(57) ABSTRACT

Some embodiments provide techniques for detecting presence of malicious software in a computing asset. The techniques identify, from among a plurality of memory locations allocated for use by a process managed by an operating system (OS) associated with the computing asset, memory location(s) to monitor in furtherance of detecting presence of malicious software in the computing asset, monitor threads initialized by the process using the identified memory location(s) to determine a number of threads so initialized, identify value(s) for visibility characteristic(s) of the process indicative of whether the process is attempting to evade detection of its execution on the computing asset, and determine whether the process is a malicious software process based on the number of threads and the value(s) for the visibility characteristic(s).

### BACKGROUND

Various types of malicious software may be used to gain unauthorized access to a computing device. One example of malicious software is ransomware. Ransomware restricts access to data (e.g., file(s) and/or other artifact(s)) in some way and demands payment of a ransom to remove the restriction. For example, the ransomware may encrypt files stored in the memory of a computing device such that they are practically impossible to decrypt without paying a ransom for the encryption key. As another example, the ransomware may lock a user from using the computing device while displaying messages demanding a ransom.

### SUMMARY

Some embodiments provide techniques for detecting the presence of malicious software in a computing asset (e.g., a physical device or a virtual device) that is part of a computing environment. The techniques monitor processes executed by the computing asset to identify those that are behaving with characteristics of malicious software. To monitor a particular process, the techniques: (1) identify any suspicious memory locations allocated for use by the process; and (2) monitor actions performed using the suspicious memory locations. If the process exhibits visibility characteristics that indicate that the process is attempting to evade detection, the process may be identified as malicious.

Some embodiments provide a method for detecting presence of malicious software in a computing asset that is part of a computing environment. The method comprises: using one or more processors to perform: identifying, from among a plurality of memory locations allocated for use by a process managed by an operating system (OS) associated with the computing asset. at least one memory location to monitor in furtherance of detecting presence of malicious software in the computing asset; monitoring threads initialized by the process using the at least one identified memory location to determine a number of threads so initialized; identifying one or more values for one or more visibility characteristics of the process, each visibility characteristic value being indicative of whether the process is attempting to evade detection of its execution on the computing asset; and determining whether the process is a malicious software process based on the number of threads and the one or more values for the one or more visibility characteristics.

In some embodiments, the method further comprises triggering monitoring of threads initialized by the process using the at least one identified memory location in response to identifying the at least one memory location to monitor in furtherance of detecting presence of malicious software in the computing asset.

In some embodiments, identifying, from among the plurality of memory locations allocated for use by the process managed by the operating system (OS) associated with the computing asset, the at least one memory location to monitor in furtherance of detecting presence of malicious software in the computing asset comprises: determining that data stored in and/or associated with the at least one memory location was modified during runtime of the process; and identifying the at least one memory location to monitor in furtherance of detecting presence of malicious software in the computing asset in response to determining that the at least one memory location was modified during execution of the process.

In some embodiments, the method further comprises, after initialization of the process, monitoring memory locations allocated by the OS to identify the plurality of memory locations allocated for use by the process.

In some embodiments, monitoring the threads initialized by the process using the at least one memory location to determine the number of threads so initialized comprises: determining whether a first instruction to be executed by a thread is an instruction from the at least one memory location; and determining that the thread is initialized by the process when it is determined that the first instruction to be executed by the thread is an instruction from the at least one memory location. In some embodiments, determining whether the first instruction to be executed by the thread is an instruction from the at least one memory location comprises: determining whether the first instruction to be executed by the initialized thread is an instruction used for launching processes in a runtime environment; and determining that the first instruction to be executed by the initialized thread is an instruction from the at least one memory location when it is determined that the first instruction to be executed by the initialized thread is not an instruction used for launching processes in a runtime environment.

In some embodiments, identifying the one or more values for the one or more visibility characteristics for the process comprises: determining that the number of threads initialized by the process using the at least one memory location meets or exceeds a threshold number of threads; and identifying the one or more values for the one or more visibility characteristics in response to determining that the number of threads initialized by the process using the at least one memory location meets or exceeds the threshold number of threads.

In some embodiments, the method further comprises the one or more visibility characteristics comprise at least one of: a graphical user interface (GUI) characteristic indicating whether the process is associated with a GUI; a signature characteristic indicating whether the process is signed with an invalid signature; a location access characteristic indicating whether the process accesses one or more particular data locations of the computing asset; an installation characteristic indicating whether data accessed by the process was installed on the computing asset using an installation application associated with the OS; and a module characteristic of a module used by the process to initiate at least one of the threads.

In some embodiments, the method further comprises terminating the process when it is determined that the process is a malicious software process based on the number of threads and the one or more values for the one or more visibility characteristics. In some embodiments, the method further comprises generating an alert in a graphical user interface (GUI) of a software application when it is determined that the process is a malicious software process based on the number of threads and the one or more values for the one or more visibility characteristics.

In some embodiments, the method further comprises: tracking data manipulation performed by the process; and reversing the data manipulation performed by the process when it is determined that the process is a malicious software process based on the number of threads and the one or more values for the one or more visibility characteristics.

Some embodiments provide a non-transitory computer-readable storage medium storing instructions that, when executed by one or more processors, causes the one or processors to perform a method for detecting presence of malicious software in a computing asset that is part of a computing environment. The method comprises: identifying, from among a plurality of memory locations allocated for use by a process managed by an operating system (OS) associated with the computing asset. at least one memory location to monitor in furtherance of detecting presence of malicious software in the computing asset; monitoring threads initialized by the process using the at least one identified memory location to determine a number of threads so initialized; identifying one or more values for one or more visibility characteristics of the process, each visibility characteristic value being indicative of whether the process is attempting to evade detection of its execution on the computing asset; and determining whether the process is a malicious software process based on the number of threads and the one or more values for the one or more visibility characteristics.

In some embodiments, the method further comprises triggering monitoring of threads initialized by the process using the at least one identified memory location in response to identifying the at least one memory location to monitor in furtherance of detecting presence of malicious software in the computing asset.

In some embodiments, identifying, from among the plurality of memory locations allocated for use by the process managed by an operating system (OS) associated with the computing asset, the at least one memory location to monitor in furtherance of detecting presence of malicious software in the computing asset comprises: determining that data stored in and/or associated with the at least one memory location was modified during runtime of the process; and identifying the at least one memory location to monitor in furtherance of detecting presence of malicious software in the computing asset in response to determining that the at least one memory location was modified during execution of the process. In some embodiments, the method further comprises: after initialization of the process, monitoring memory locations allocated by the OS to identify the plurality of memory locations allocated for use by the process. In some embodiments. monitoring threads initialized by the process using the at least one memory location to determine the number of threads so initialized comprises: determining whether a first instruction to be executed by a thread is an instruction from the at least one memory location; and determining that the thread is initialized by the process when it is determined that the first instruction to be executed by the thread is an instruction from the at least one memory location.

In some embodiments, identifying the one or more values for the one or more visibility characteristics for the process comprises: determining that the number of threads initialized by the process using the at least one memory location meets or exceeds a threshold number of threads: and identifying the one or more values for the one or more visibility characteristics in response to determining that the number of threads initialized by the process using the at least one memory location meets or exceeds the threshold number of threads.

In some embodiments, identifying the one or more values for the one or more visibility characteristics for the process comprises: determining that the number of threads initialized by the process using the at least one memory location meets or exceeds a threshold number of threads; and identifying the one or more values for the one or more visibility characteristics in response to determining that the number of threads initialized by the process using the at least one memory location meets or exceeds the threshold number of threads.

In some embodiments, the one or more visibility characteristics comprise at least one of: a graphical user interface (GUI) characteristic indicating whether the process is associated with a GUI; a signature characteristic indicating whether the process is signed with an invalid signature: a location access characteristic indicating whether the process accesses one or more particular data locations of the computing asset; an installation characteristic indicating whether data accessed by the process was installed on the computing asset using an installation application associated with the OS; and a module characteristic of a module used by the process to initiate at least one of the threads.

Some embodiments provide a system for detecting presence of malicious software in a computing asset that is part of a computing environment. The system comprises: at least one processor; and at least one non-transitory computer-readable storage medium storing instructions. The instructions, when executed by the at least one processor, cause the at least one processor to perform: identifying, from among a plurality of memory locations allocated for use by a process managed by an operating system (OS) associated with the computing asset, at least one memory location to monitor in furtherance of detecting presence of malicious software in the computing asset; monitoring threads initialized by the process using the at least one identified memory location to determine a number of threads so initialized; identifying one or more values for one or more visibility characteristics of the process, each visibility characteristic value being indicative of whether the process is attempting to evade detection of its execution on the computing asset; and determining whether the process is a malicious software process based on the number of threads and the one or more values for the one or more visibility characteristics.

The foregoing summary is non-limiting.

### BRIEF DESCRIPTION OF DRAWINGS

Various aspects and embodiments will be described with reference to the following figures. It should be appreciated that the figures are not necessarily drawn to scale. Items appearing in multiple figures are indicated by the same or a similar reference number in all the figures in which they appear.

FIG. 1A shows an example computing environment in which some embodiments of the technology described herein may be implemented.

FIG. 1B shows an example of malware detection performed on a computing asset in the computing environment of FIG. IA by a respective malware detection module, according to some embodiments of the technology described herein.

FIG. 2A shows example modules of a malware detection module, according to some embodiments of the technology described herein.

FIG. 2B illustrates interaction between the modules of the malware detection module shown in FIG. 2A, according to some embodiments of the technology described herein.

FIG. 3 shows an example process for detecting presence of malicious software in a computing asset, according to some embodiments of the technology described herein.

FIG. 4 shows a block diagram of an exemplary computing device, in accordance with some embodiments of the technology described herein.

### DETAILED DESCRIPTION

The inventors have developed techniques for detecting the presence of malicious software in a computing asset. For example, the techniques may be used for detecting ransomware executing on computing asset(s) in a computing environment. When the presence of malicious software is detected, one or more actions to mitigate risk may be performed (e.g., termination of a process associated with the malicious software, alerting a system administrator or security professional, and/or performing additional or more detailed monitoring of the process).

One challenge with detecting the presence of malicious software (“malware”) in a computing asset is that the malware may behave in a manner that is difficult to distinguish from legitimate software. Execution of the malware may result in performing actions that can also be performed legitimately by other types of software. This makes it difficult to detect the presence of malware on the computing asset. Conventional techniques of detecting malware rely on monitoring such actions to identify the malware. Given the resemblance between actions of the malware and benign software, conventional techniques have high error rates with high false alarm rate (e.g., frequently flagging a benign process as malware) or high missed detection rate (e.g., frequently failing to recognize malware as such).

As an illustrative example, one type of malware is ransomware that, when executed, may perform actions such as enumerating files, accessing and reading file content, creating new files, and/or encrypting memory buffers. These are actions that are performed frequently (e.g., every second) by legitimate and non-malicious software applications. For example, archiving involves enumerating files to be archived, reading content from the files, and/or deleting original files. As another example, a file may be password protected by opening the file, reading its content. encrypting the content with a password, and overwriting the content. Given that a ransomware attack involves activity resembling that of legitimate archiving and file password protection, identifying the ransomware as a threat based on such activities is ineffective.

Accordingly, the inventors have developed improved techniques for detecting the presence of malware computing assets. A malware detection system monitors an application's interaction with an operating system (OS) associated with (e.g., installed on and/or managing processing on) the computing asset to characterize it in a way that distinguishes malicious software from legitimate software more effectively than conventional techniques. In particular, the system identifies suspicious memory locations allocated by the OS for use in the execution of a software application and monitors threads initialized using those memory locations. The system further identifies characteristics of the software application that indicate whether it is attempting to evade detection during its execution.

Embodiments described herein improve over conventional techniques of detecting malware by more accurately differentiating malware from legitimate software. By monitoring an OS' allocation of memory and thread initialization during execution of a software application, and determining whether the software application is trying to evade detection, the techniques can more accurately distinguish malware from legitimate software, despite some similarities among them. For example, a ransomware process operates by launching multiple threads to encrypt a victim's data. By monitoring an OS' allocation of memory and thread initialization for the ransomware process, embodiments described herein can identify the ransomware process as malicious before it encrypts data and thus prevent a ransomware attack (e.g., by terminating the ransomware process, limiting data accessible by the ransomware process, generating an alert, and/or performing another preventative action).

Some embodiments provide a technique for detecting presence of malicious software in a computing asset (e.g., a virtual device or a physical device) that is part of a computing environment (e.g., a cloud computing environment). The technique involves: (1) identifying, from among a plurality of memory locations allocated for use by a process managed by an operating system (OS) (e.g., Microsoft WINDOWS™ OS, MAC™ OS, ANDROID™ O) S, and/or another OS) associated with the computing asset, at least one memory location to monitor in furtherance of detecting the presence of malicious software in the computing asset; (2) monitoring threads initialized by the process using the at least one identified memory location (e.g., by monitoring requests made to the OS) to determine the number of threads so initialized; (3) identifying one or more values for one or more visibility characteristics for the process, each visibility characteristic value indicative of whether the process is attempting to evade detection of its execution on the computing asset; and (4) determining whether the process is a malicious software process based on the number of threads and the one or more values for the one or more visibility characteristics.

In some embodiments, identifying, from among the plurality of memory locations allocated for use by the process managed by the OS associated with the computing asset, the at least one memory location in furtherance of detecting the presence of malicious software comprises identifying memory locations that store executable instructions. In some embodiments. identifying, from among the plurality of memory locations allocated for use by the process managed by the OS associated with the computing asset, the at least one memory location in furtherance of detecting the presence of malicious software comprises identifying any memory locations which had content stored therein modified after the process was initialized. For example. the system may identify any memory locations which were modified by storing new executable instructions (e.g., copied from another source) at the memory locations.

In some embodiments, the technique further comprises triggering monitoring of threads initialized by the process using the at least one identified memory location in response to identifying the at least one memory location to monitor in furtherance of detecting presence of malicious software in the computing asset. In some embodiments, identifying, from among the plurality of memory locations allocated for use by the process managed by the operating system (OS) associated with the computing asset, the at least one memory location to monitor in furtherance of detecting presence of malicious software in the computing asset comprises: (1) determining that data stored in and/or associated with the at least one memory location was modified (e.g., decrypted and/or downloaded from another source) during runtime of the process; and (2) identifying the at least one memory location to monitor in furtherance of detecting presence of malicious software in the computing asset in response to determining that the at least one memory location was modified during execution of the process.

In some embodiments, the technique further comprises, after initialization of the process, monitoring memory locations allocated by the OS to identify the plurality of memory locations allocated for use by the process. In some embodiments, monitoring the threads initialized by the process using the at least one memory location to determine the number of threads so initialized comprises: (1) determining whether a first instruction to be executed by an initialized thread is an instruction from the at least one memory location; and (2) determining that the thread is initialized by the process when it is determined that the first instruction to be executed by the thread is an instruction from the at least one memory location. In some embodiments. determining whether the first instruction to be executed by the thread is an instruction from the at least one memory location comprises: (1) determining whether the first instruction to be executed by the initialized thread is an instruction used for launching processes in a runtime environment (e.g., an instruction associated with the _RtlUser ThreadStart function or another function for launching processes in a runtime environment); and (2) determining that the first instruction to be executed by the initialized thread is an instruction from the at least one memory location when it is determined that the first instruction to be executed by the initialized thread is not an instruction used for launching processes in a runtime environment.

In some embodiments, identifying the one or more values for the one or more visibility characteristics for the process comprises: (1) determining that the number of threads initialized by the process using the at least one memory location meets or exceeds a threshold number of threads (e.g., 5 threads); and (2) identifying the one or more values for the one or more visibility characteristics in response to determining that the number of threads initialized by the process using the at least one memory location meets or exceeds the threshold number of threads.

In some embodiments, the one or more visibility characteristics comprise at least one of: a graphical user interface (GUI) characteristic indicating whether the process is associated with a GUI, a signature characteristic indicating whether the process is signed with an invalid signature, a location access characteristic indicating whether the process accesses one or more particular data locations of the computing asset, an installation characteristic indicating whether data accessed by the process was installed on the computing asset using an installation application associated with the OS, and a module characteristic of a module used by the process to initiate at least one of the threads.

In some embodiments, the technique comprises terminating the process when it is determined that the process is a malicious software process based on the number of threads and the one or more values for the one or more visibility characteristics. In some embodiments, the technique comprises generating an alert in a graphical user interface (GUI) of a software application when it is determined that the process is a malicious software process based on the number of threads and the one or more values for the one or more visibility characteristics.

In some embodiments, the technique comprises: (1) tracking data manipulation performed by the process; and (2) reversing the data manipulation performed by the process when it is determined that the process is a malicious software process based on the number of threads and the one or more values for the one or more visibility characteristics.

Some example embodiments described herein may involve the WINDOWS™ OS as an example OS associated with a computing asset being monitored for malware detection. However, the WINDOWS™ OS is used for illustrative purposes and embodiments described may be used with other operating systems, non-limiting examples of which are provided herein.

Following below are more detailed descriptions of various concepts related to, and embodiments of. malware detection systems and methods developed by the inventors. It should be appreciated that various aspects described herein may be implemented in any of numerous ways. Examples of specific implementations are provided herein for illustrative purposes only. In addition, the various aspects described in the embodiments below may be used alone or in any combination and are not limited to the combinations explicitly described herein.

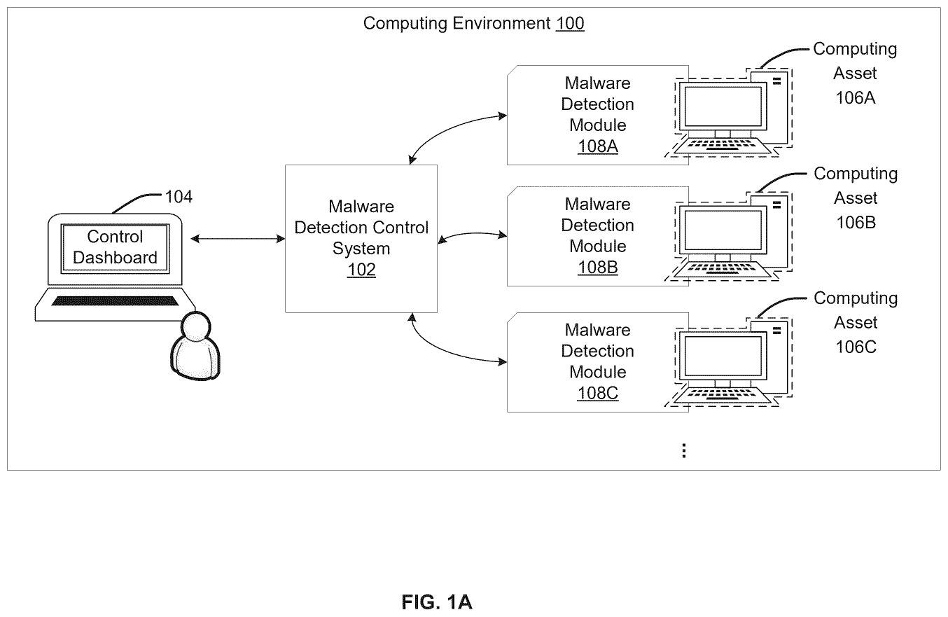

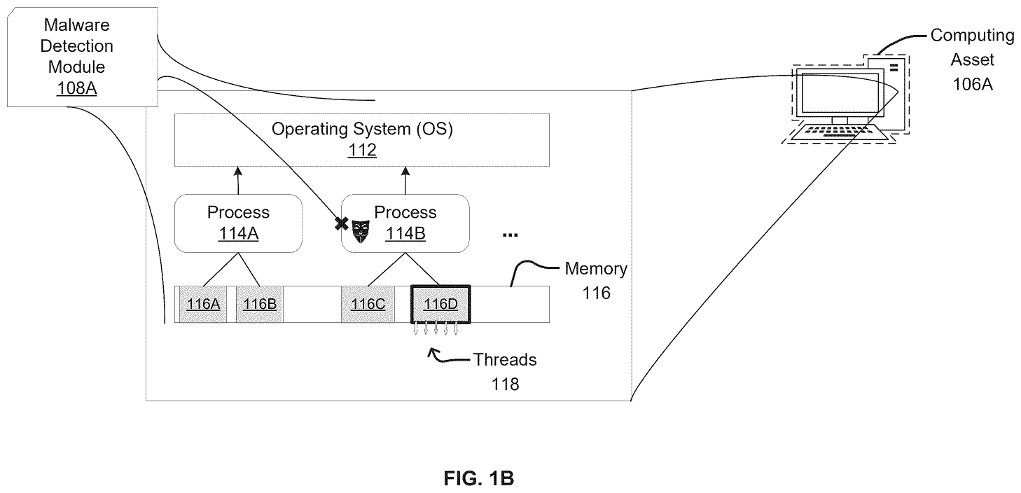

FIG. 1A illustrates an example computing environment 100 in which some embodiments of the technology described herein may operate. The computing environment 100 includes multiple computing assets 106A, 106B, 106C. Each of the computing assets 106A, 106B, 106C is monitored by a respective one of malware detection modules 108A, 108B, 108C. Malware detection modules 108A, 108B, 108C are configured to communicate with a malware detection control system 102. A device 104 may be used by a user to view information collected from malware detection modules 108A, 108B, 108C and configure operation of malware detection modules 108A, 108B, 108C.

A computing asset of the computing environment 100 may be any addressable physical or virtual device on the computer network. A computing asset may have one or multiple addresses on the computer network. Each address may be of any suitable type and may be used to enable communication to/from the device on the computer network. Non-limiting examples of addresses include an IP address (e.g., an IPv4 or an IPv6 address), a MAC address, an FTP address, an HTTP address, and a hostname. As can be appreciated from the foregoing, when a device has multiple addresses, different addresses may be used to enable communication to/from the device using different communication protocols. Though, some communication protocols may require use of multiple addresses (e.g., IP address and MAC address). Some types of addresses may be assigned by a network (e.g., an IP address). Other types of addresses are not assigned by the network and are particular to a device (e.g., a MAC address). Examples of computing assets which are physical devices include any physical device including any portable device and any fixed device. Non-limiting examples of portable devices include a smartphone, a smartwatch, a tablet computer, a laptop, a speaker, a printer, a camera, or any other suitable network-enabled mobile device. Non-limiting examples of a fixed device include a desktop computer, a rack-mounted computer, a server, a network switch, a network router, or any other network-enabled piece of equipment (e.g., a large printer, a copy machine, a refrigerator, etc.). Internet of Things (IoT) devices such as smart home devices (e.g., smart refrigerators, doorbells, cameras, thermostats, vehicles, security systems) are also examples of physical computing assets. Examples of computing assets which are virtual devices include virtual machines and containers. Virtual machines may virtualize an entire machine down to the hardware layers. Containers may virtualize only software layers above the OS level. One or more containers may share an OS.

Computing environment 100 may be any computing environment that includes one or more computing assets (e.g., physical devices and/or virtual devices). In some embodiments, computing environment 100 may be a cloud computing environment in which each of computing assets 106A, 106B, 106C is a virtual device (e.g., a virtual machine and/or a container). In some embodiments, computing environment 100 may be a client server environment in which each of computing assets 106A, 106B, 106C is a physical device that accesses one or more services from a server. In some embodiments, computing environment 100 may be a distributed computing environment in which computing assets 106A, 106B, 106C are physically distributed nodes that are linked through a network. The nodes may communicate with each other and execute processes together, In some embodiments, computing environment 100 may be a cluster computing environment that includes multiple physical devices working in parallel with one another.

In some embodiments, malware detection control system 102 may be configured to collect information from malware detection modules 108A, 108B, 108C. Malware detection control system 102 may be configured to receive information about processes collected by malware detection modules 108A, 108B, 108C. Information about a given process may include information identifying the process (e.g., an application name, serial number, and/or other information uniquely identifying the process), information about the process' interaction with an OS associated with a computing asset, information about one or more visibility characteristic(s) of the process, and/or other information about the process. In some embodiments, information about the process' interaction with the OS may include an indication of memory locations allocated for the process by the OS, an indication of memory locations that are being monitored in furtherance of detecting presence of malware in the computing asset (e.g., because the memory locations were flagged as suspicious), and information about one or more threads initialized by the process (e.g., a number of threads, instruction sequence(s) to be executed by the thread(s), and/or other information about the thread(s)). Malware detection control system 102 may be configured to receive indications of malware detected by malware detection modules 108A, 108B, 108C.

In some embodiments, malware detection control system 102 may be configured to configure monitoring operation of malware detection modules 108A, 108B, 108C. In some embodiments, the malware detection control system 102 may be configured to set functions that are monitored to detect creation of threads by a process being monitored. For example, malware detection control system 102 may specify, for a given malware detection module, a set of OS functions to use for identifying threads initialized by a process (e.g., by specifying a set of application program interface (API) calls to monitor). In some embodiments, malware detection control system 102 may be configured to set a threshold value of parameters used by malware detection modules 108A, 108B, 108C in performing detection. For example, malware detection control system 102 may set, for a given malware detection module, a threshold number of threads initialized by a process from a particular memory location that triggers additional monitoring functionality (e.g., to determine visibility characteristics of a process).

In some embodiments, malware detection control system 102 may be configured to configure a response mechanism of malware detection modules 108A, 108B, 108C to detection of malware. The malware detection control system 102 may configured to determine a response mechanism for a given malware detection module and configure the malware detection module accordingly. For example, the malware detection control system 102 may determine whether the malware detection module is to ignore detected malware, monitor the malware (e.g., by collecting information about the malware), or terminate execution of the malware. In some embodiments, malware detection control system 102 may be configured to configure malware detection modules 108A, 108B, 108C to revert operations performed by detected malware. For example, the malware detection control system 102 may configure a malware detection module to: (1) store a log of operations performed by a process; and (2) reverse the operations in response to detecting that the process is a malware process (e.g., by undoing each of the operations and/or restoring data to a state prior to modification by the process).

In some embodiments, malware detection control system 102 may be configured to configure malware detection modules 108A, 108B, 108C based on input received from user device 104. For example, the malware detection control system 102 may provide a graphical user interface (GUI) that includes a dashboard through which the user may configure malware detection modules 108A, 108B, 108C. In some embodiments, malware detection control system 102 may be configured to display information collected from malware detection modules 108A, 108B, 108C on device 104. For example, malware detection control system 102 may provide a GUI that displays visualizations of information received from malware detection modules 108A, 108B, 108C (e.g., an indication of processes being monitored, detected malware, memory locations flagged for monitoring in furtherance of malware detection, information about threads initialized by processes, visibility characteristic values of processes, response to detected malware, and/or other information) and/or parameter values derived therefrom.

In some embodiments, each of malware detection modules 108A, 108B, 108C may be configured to detect malware on a respective one of computing assets 106A, 106B, 106C. FIG. 1B shows an example of malware detection performed on computing asset 106A by malware detection modules 108A, according to some embodiments of the technology described herein. Malware detection modules 108A monitors processes 114A, 114B being executed by computing asset 106A. In the example of FIG. 1B, process 114B is a malware process as indicated by the mask symbol in the box labeled “114B”. As described in further detail below, malware detection module 108A identifies process 114B as malware and activates a response mechanism (e.g., that terminates process 114B, collects additional information about process 114B, and/or another response mechanism).

As illustrated in FIG. 1B, OS 112 allocates locations (e.g., addresses) in memory 116 of computing asset 106A for use by processes 114A, 114B. In the example of FIG. 1B, OS 112 allocates memory locations 116A, 116B for use by process 114A and locations 116C, 116D for use by process 114B. In some embodiments, malware detection module 108A may be configured to monitor which memory locations are allocated for each of processes 114A, 114B. Malware detection module 108A may be configured to monitor memory locations allocated for a process by tracking which areas of memory were allocated by the OS 112 after the initialization of the process. Malware detection module 108A may be configured to associate memory locations allocated after initialization of the process (e.g., after computing asset 106A begins execution of a software application that instantiates the process). For example, malware detection module 108A may generate a data record storing an indication of the process and one or more memory addresses allocated for the process by OS 112. In the example of FIG. 1B, malware detection module 108A may generate a data record for process 114A storing an identifier for process 114A and an indication of memory addresses allocated for process 114A, and generate a data record for process 114B storing an identifier for process 114B and an indication of memory addresses allocated for process 114B. In some embodiments, malware detection module 108A may be configured to determine and store information about each memory location allocated for a process (e.g., whether the memory location stores data or instructions, whether the content stored in and/or associated with the memory location was changed after runtime. and/or other information). Such information may also be referred to herein as “metadata” about the memory location.

In some embodiments, malware detection module 108A may be configured to identify a memory location for further monitoring for detection of malware using metadata determined about the memory location. An identified such memory location may also be referred to as a “flagged memory location”. In some embodiments, malware detection module 108A may be configured to: (1) determine whether the content stored in a memory location and/or associated with the memory location was modified at runtime; and (2) determine to flag the memory location for further monitoring when it is determined that the content was modified at runtime. Content associated with a memory location may include, for example, information indicating whether the memory location is read-only. In the example of FIG. 1B, malware detection module 108A may determine metadata about memory location 116D allocated for use by process 114B, and flag memory location 116D for further monitoring based on the metadata. For example, malware detection module 108A may determine that instructions stored at memory location 116D were modified at runtime and, in response, determine to flag memory location 116D for further monitoring.

In some embodiments, malware detection module 108A may be configured to perform further monitoring functions for a flagged memory location. Malware detection module 108A may be configured to monitor threads initiated using the memory location. Malware detection module 108A may be configured to monitor the threads to determine a number of threads initialized using the memory location. For example, malware detection module 108A may determine a number of threads initialized to execute instructions from the flagged memory location. In some embodiments, malware detection module 108A may be configured to determine a number of threads initialized to execute instructions from all flagged memory locations allocated for the process.

In the example of FIG. 1B, malware detection module 108A performs further monitoring on flagged memory location 116D. In the example of FIG. 1B, malware detection module 108A may monitor a number of threads initialized using memory location 116D. Malware detection module 108A may be configured to track the number of threads initialized using the memory location 116D (e.g., a number of threads initialized to execute instructions from memory location 116D). In some embodiments, malware detection module 108A may be configured to determine that process 114B is to be further analyzed (e.g., to determine visibility characteristic(s) of process 114B) when a threshold number of threads (e.g., 1, 2, 3, 4, 5. 6, 7, 8, 9, or 10) is initialized from the memory location (e.g., to execute instructions from the memory location). In some embodiments, malware detection module 108A may be configured to determine that process 114B is to be further analyzed when a threshold number of threads is initialized from all flagged memory locations. As an illustrative example, malware detection module 108A may detect a new thread initialized every 1 second by a process. After 5 seconds, when malware detection module 108A has detected a threshold of 5 threads initialized, malware detection module 108A may identify process 114B as malware (e.g., based on visibility characteristic(s)).

In some embodiments, malware detection module 108A may be configured to determine one or more values of one or more visibility characteristics of a process (e.g., when a memory location allocated for the process was flagged for further monitoring). The visibility characteristic(s) may indicate whether the process is attempting to evade detection. Example visibility characteristic(s) are described herein. In some embodiments, malware detection module 108A may be configured to determine whether a process is a malware process using the value(s) indicating visibility characteristic(s) of the process. In the example of FIG. 1B, malware detection module 108A may be configured to determine value(s) of visibility characteristic(s) of process 114B and determine whether process 114B is a malware process based on the value(s) of the visibility characteristic(s).

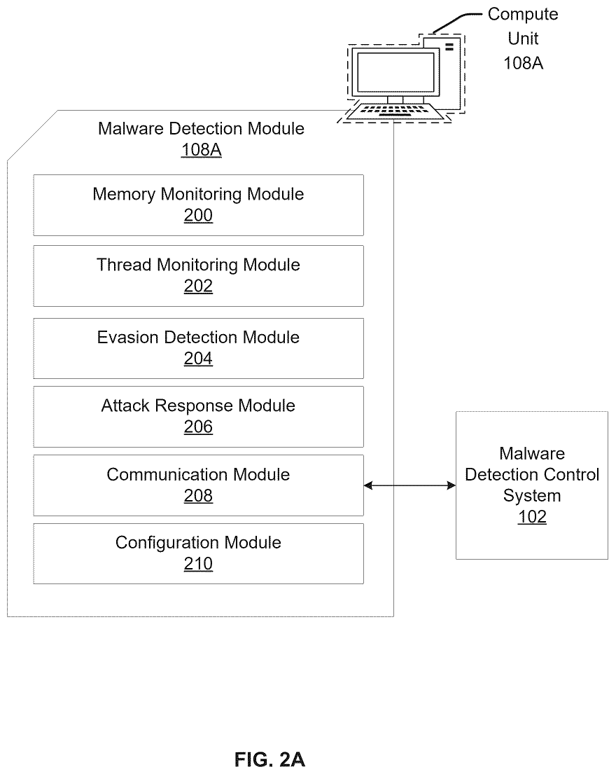

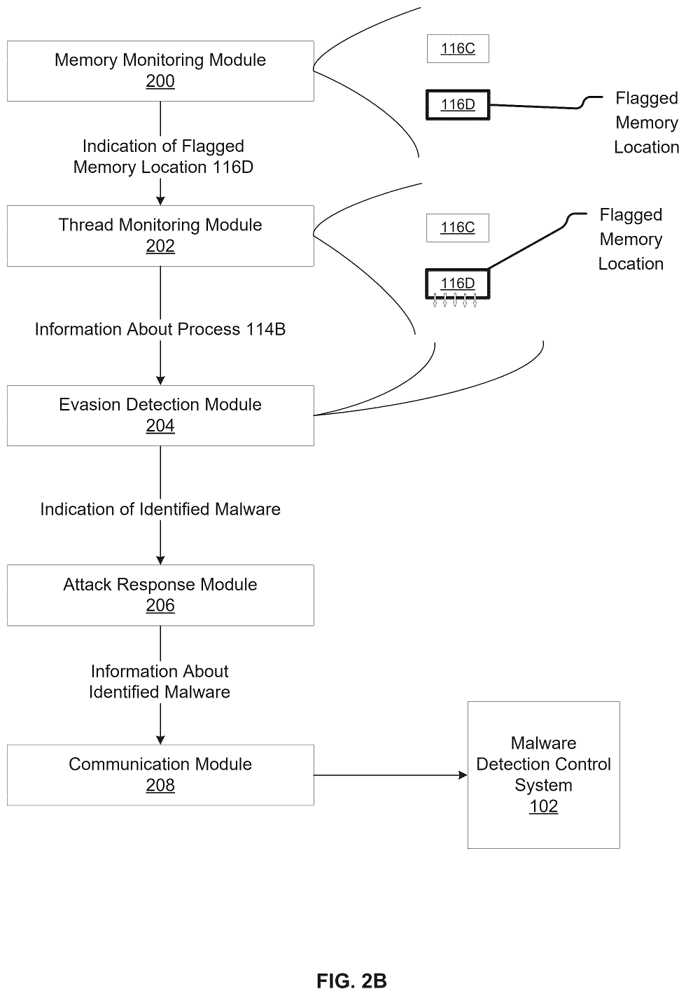

As illustrated in FIG. 1B, in some embodiments, malware detection module 108A may be configured to execute a response when process 114B is identified as malware. Example responses are described herein with reference to FIGS. 2A-2B.

FIG. 2A shows example modules of malware detection module 108A that perform malware detection (e.g., as described herein with reference to FIG. 1B), according to some embodiments of the technology described herein. The modules include memory monitoring module 200, thread monitoring module 202, evasion detection module 204, attack response module 206, and communication module 208. FIG. 2B illustrates interaction between modules of the malware detection module 108A shown in FIG. 2A, according to some embodiments of the technology described herein.

In some embodiments, memory monitoring module 200 may be configured to monitor allocation of memory locations by OS 112 associated with computing asset 106A for use by a process. The memory monitoring module 200 may be configured to: (1) detect initialization of a process; and (2) identify memory location(s) allocated after detecting initialization of the process as memory locations allocated for the process. For example, memory monitoring module 200 may identify an event indicated by OS 112 (e.g., in an event log) indicating that a new process has initiated and identify memory location(s) allocated after detecting the event. In some embodiments, memory monitoring module 200 may be configured to monitor memory location(s) allocated on a process heap of OS 112. As shown in FIG. 2B, memory monitoring module 200 has identified memory locations 116C, 116D allocated for process 114B.

In some embodiments, memory monitoring module 200 may be configured to determine metadata about the allocated memory locations. For example, memory monitoring module 200 may determine whether the memory location stores executable instructions, whether it contains data, and/or whether it was modified at runtime. In some embodiments, memory monitoring module 200 may be configured to track changes to contents of memory location(s) allocated for a process. For example, memory monitoring module 200 may track changes to instructions and/or data stored in a memory location.

In some embodiments, memory monitoring module 200 may be configured to identify one or more of a set of memory locations allocated for a process by OS 112 for further monitoring to detect malware. Memory monitoring module 200 may flag a memory location for further monitoring by determining whether content stored in the memory location was modified at runtime and flagging the memory location for further monitoring when it is determined that the content stored in the memory location was modified at runtime. For example, memory monitoring module 200 may determine whether content of the memory location 116D was modified by determining whether new instructions were generated and stored in the memory location (e.g., by decrypting an encrypted buffer, copied from another source, and/or generated using other resources), and flag memory location 116D for further monitoring when it is determined that the content was modified. As shown in FIG. 2B, memory monitoring module 200 may be configured to transmit an indication of flagged memory location 116D to thread monitoring module 202 (e.g., by transmitting a pointer and/or memory address to thread monitoring module 202).

In some embodiments, thread monitoring module 202 may be configured to monitor threads initiated using flagged memory location(s). In some embodiments, thread monitoring module 202 may be configured to monitor a number of threads initiated using the memory location. For example, thread monitoring module 202 may identify threads initialized to execute instruction sequences obtained using memory location 116D. In some embodiments, thread monitoring module 202 may be configured to identify new threads by determining whether process 114B has used any of a predetermined set of functions to initialize a thread using memory location 116D. For example, in a system in which OS 112 is a Microsoft WINDOWS™ OS, thread monitoring module 202 may determine whether process 114B has made one or more of the following function calls to the OS: NtSetInformation Thread, Nt Write VirtualMemory, NtClose, NtMapViewOfSection, NtCreate Thread, Create Thread, CreateRemoteThread, NtQueueApcThread, and/or one or more other functions. In some embodiments, the predetermined set of functions tracked by thread monitoring module 202 may be functions that perform certain actions. For example, the predetermined set of functions may be those that manipulate files, start other threads, use encryption functions, and/or have other properties. In some embodiments, thread monitoring module 202 may be configured to determine a number of threads initialized from a flagged memory location. In the example of FIG. 2B, thread monitoring module 202 may determine the number of threads initialized using memory location 116D.

In some embodiments, thread monitoring module 202 may be configured to trigger operation of evasion detection module 204 based on monitoring threads initiated using flagged memory location 116D. Thread monitoring module 202 may be configured to trigger operation of evasion detection module 204 based on a number of threads initialized using flagged memory location 116D. For example, thread monitoring module 202 may trigger operation of evasion detection module 204 when thread monitoring module 202 determines that a threshold number of threads have been initialized using memory location 116D. Example threshold values are described herein with reference to FIG. 1B. In some embodiments, thread monitoring module 202 may be configured to trigger operation of evasion detection module 204 based on one or more characteristics of threads initialized using flagged memory location 116D. For example, thread monitoring module 202 may trigger operation of evasion detection module 204 based on instruction sequence(s) that initialized thread(s) are to execute. It should be appreciated that in some embodiments, evasion detection module 204 may be configured to operate independently of thread monitoring module 202 (e.g., without being triggered by thread monitoring module 202).

In some embodiments, evasion detection module 204 may be configured to determine whether a process (e.g., process 114B) is attempting to avoid detection. Evasion detection module 204 may be configured to determine whether the process is attempting to avoid detection by determining value(s) of visibility characteristic(s) and determining whether the process is attempting to avoid detection using the visibility characteristic value(s). Visibility characteristic(s) may include a GUI characteristic indicating whether the process has an associated visible GUI (e.g., a window in a computing asset associated with a Microsoft WINDOWS™ OS, a mobile application GUI in a smartphone, and/or other GUI), a signature characteristic indicating whether the process is signed with an invalid signature (e.g., that is expired, revoked, or that does not fit a product description), a location access characteristic indicating whether the process accesses a particular data location of the computing asset (e.g., a particular folder in a file system), an installation characteristic indicating whether data accessed by the process was installed using an installation application associated with OS 112, a decryption characteristic indicating whether content stored in memory location(s) was decrypted at runtime (e.g., to avoid access detection), a download characteristic indicating whether content stored in memory location(s) was downloaded from another source (e.g., accessed through the Internet), an extension characteristic indicating whether the process has a file extension for executable files that is not among a set of known file extensions, a malware history characteristic indicating whether the process is associated with an application previously identified as malware, an encryption operation characteristic indicating a number of encryption operations, a data modification characteristic indicating a number of datasets (e.g., files) modified by the process, a longevity characteristic indicating whether file(s) associated with the process have existed in memory of a computing asset for greater than a threshold amount of time (e.g., an amount of time in a range of 1-6 months, 6-12 months, 1-2 years, or another amount of time), a frequency characteristic indicating a frequence of use of file(s) associated with the process, a privilege characteristic indicating privileges granted to the process by OS 112 (e.g., whether the process has access to resource(s)), and/or other visibility characteristic(s). As shown in the example of FIG. 2B, in some embodiments, evasion detection module 204 may be configured to determine the value(s) of the visibility characteristic(s) using information about process 114B obtained by thread monitoring module 202 and/or memory monitoring module 200.

In some embodiments, evasion detection module 204 may be configured to analyze requests (e.g., API calls) to OS 112 and responses thereto. Evasion detection module 204 may be configured to determine a module that issued a given request. For example, evasion detection module 204 may intercept an API call to initialize a thread, determine a return address of a current call stack of the thread, and determine which module (e.g., dynamic link library (DLL)) initiated the API call based on the return address. In some embodiments, evasion detection module 204 may be configured to determine visibility characteristic(s) that are characteristic(s) of a module (“module characteristic(s)”). For example, module characteristic(s) may include a location (e.g., a folder of a file system) of the module, the validity of a certificate of the module, and/or other module characteristic(s).

Evasion detection module 204 may be configured to determine whether a process is attempting to avoid detection using visibility characteristic value(s) in various ways. For example, malware detection module 108A may determine that process 114B is a malware process when a threshold number of visibility characteristic value(s) indicate that process 114B is attempting to evade detection. As another example, malware detection module 108A may determine that process 114B is a malware process when a particular subset of visibility characteristic value(s) indicate that process 114B is attempting to evade detection. In some embodiments, malware detection module 108A may be configured (e.g., by malware detection control system 102) with logic specifying how malware detection module 108A determines whether a process is a malware process using visibility characteristic value(s). The logic may specify one or more conditions determined based on the visibility characteristic value(s) that, when met, indicate the process to be a malware process.

In some embodiments, attack response module 206 may be configured to execute a response when a process is identified as a malware process. In some embodiments, attack response module 206 may be configured to terminate the process, perform additional monitoring of the process (e.g., by collecting value(s) of additional characteristic(s) beyond the visibility characteristic(s)), limit operation of the process (e.g., by preventing the process from accessing certain functions of OS 112 and/or limiting its operation in a controlled environment), and/or another response. In some embodiments. attack response module 206 may be configured to provide an alert to malware detection control system 102 indicating process 114B as malware. For example, an alert may be an alert in a GUI provided by malware detection control system 102, a communication (e.g., an email, text message, or other type of communication), activation of an alarm, and/or another alert. In some embodiments. attack response module 206 may be configured to transmit the alert without modifying or restricting operation of the process (e.g., to collect data about its behavior). In some embodiments, attack response module 206 may be configured to track data modifications made by the process and reverse the modifications in response to determining the process to be a malware process.

In some embodiments, attack response module 206 may be configured (e.g., by malware detection control system 102) with a mechanism to respond to determining that a process is a malware process. For example, attack response module 206 may be configured with a response mechanism by malware detection control system 102 based on user input indicating the response mechanism (e.g., specifying a selection of one of multiple response mechanisms, logic to be executed by attack response module 206 as a response mechanism, and/or another input).

In some embodiments, communication module 208 may be configured to communicate with malware detection control system 102 described herein with reference to FIG. 1A. Communication module 208 may be configured to transmit information about memory locations (e.g., memory locations flagged for further monitoring), threads (e.g., information about threads initialized using a flagged memory location, numbers of threads flagged using a flagged memory location, and/or other information about threads), and/or a process (e.g., visibility characteristic value(s) determined for the process). In some embodiments, communication module 208 may be configured to receive configuration information from malware detection control system 102 for configuring operation of modules 200, 202, 204, 206. In some embodiments, communication module 208 may be configured to receive commands from malware detection control system 102 (e.g., user commands and/or programmatic commands).

In some embodiments, configuration module 210 may be configured to configure functionality of malware detection module 108A. Configuration module 210 may be configured to configure operation of memory monitoring module 200, thread monitoring module 202, evasion detection module 204, and attack response module 206. For example, configuration module 210 may set a number of threads initialized by a process that cause thread monitoring module 202 to trigger further functionality (e.g., of evasion detection module 204), which visibility characteristic(s) to determine by evasion detection module 204, a response of attack response module 206 to detected malware, and/or other operation. In some embodiments, configuration module 210 may be accessed through a GUI (e.g., provided by malware detection control system 102 on a user device). In some embodiments, configuration module 210 may receive configuration instructions from malware detection control system (e.g., through communication module 208). For example, configuration module 210 may receive configuration instructions from malware detection control system 102 based on user input received through a GUI provided by malware detection control system 102. Configuration module 210 may configure operation of malware detection module 108A in accordance with the configuration instructions.

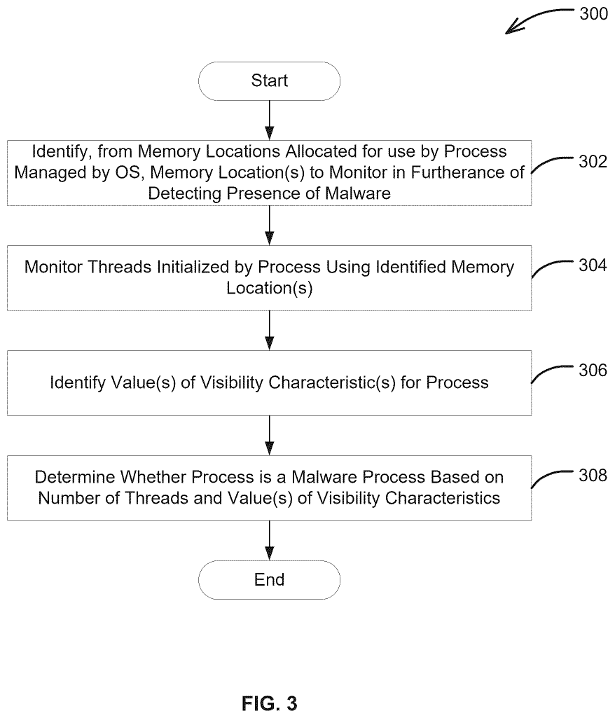

FIG. 3 is an example process 300 for detecting presence of malware (e.g., ransomware) in a computing asset (e.g., one of computing assets 106A, 106B, 106C in computing environment 100 described herein with reference to FIGS. 1A-1B), according to some embodiments of the technology described herein. In some embodiments, process 300 may be performed by one malware detection modules 108A,108B, 108C described herein with reference to FIGS. 1A-1B (e.g., to detect presence of malware on respective computing assets 106A, 106B, 106C). In some embodiments, the system may be configured to perform process 300 for each of multiple processes. For example, malware detection module 108A may perform process 300 for each process initialized from executing a software application by computing asset 106A. Process 300 begins at block 302, where the system performing process 300 identifies, from memory locations (e.g., memory addresses) allocated for use by a process managed by an OS associated with the computing asset, one or more memory locations to monitor in furtherance of detecting presence of malware. In some embodiments, the memory locations allocated for use by the process may be those allocated by the OS after initialization of the process. For example, the memory locations may be those allocated on a process heap of the OS. As another example, the memory locations may be those allocated for execution of instructions (e.g., as determined based on API functions that were used to allocate the memory locations). In some embodiments, the system may be configured to determine whether to perform further monitoring on a particular memory location allocated for use by the process by determining whether content stored in the memory location was modified at runtime (e.g., by determining whether new instructions were generated or obtained and stored in the memory location at runtime). The system may be configured to flag the memory location for further monitoring when it is determined that the particular memory location was modified at runtime.

In some embodiments, the system may be configured to determine one or more properties about the memory locations allocated for use by the process and determine whether to monitor the memory locations based on the one or more properties. For example, the system may determine whether a given memory location stores instructions. data, or both. As another example, the system may determine how instructions stored in a given memory location were generated (e.g., whether the instructions were downloaded from another source, obtained by decryption, or generated in another manner). The system may be configured to use the one or more properties to identify the memory location(s) for further monitoring. For example, the system may determine to further monitor a given memory location when its one or more properties indicate that it stores instructions that were modified at runtime.

Next, process 300 proceeds to block 304, where the system monitors threads initialized by the process using the memory location(s) identified at block 302. The system may be configured to determine a number of threads initialized to perform instructions from each of the memory location(s). In some embodiments, the system may be configured to monitor the memory location(s) by determining whether any thread creation functions have been executed by the process from the memory location(s). For example, the system may monitor the memory location(s) to detect execution of a pre-determined set of functions that, when executed, result in creation of a thread. The system may determine a number of threads created by detecting execution of those functions. In some embodiments, the system may be configured to store a thread counter for each of the memory location(s). The thread counter for a respective memory location may indicate the number of threads initialized using the memory location (e.g., as determined by the system by detection of thread creation functions).

In some embodiments, the system may be configured to identify a sequence of instructions that are to be executed by a thread, and use the instruction sequence to determine whether the thread is initialized from a given memory location. For example, the system may read an instruction register (e.g., extended instruction pointer (EIP) register, EAX register) or another register. In some embodiments, the system may be configured to only count threads that meet one or more criteria. For example, the system may count threads that manipulate data, start other threads, and/or use encryption functions.

In some embodiments, the system may be configured to count a thread as initialized from a memory location when the system determines that the thread is executing instructions from the memory location. In some embodiments, the system may be configured to determine whether the thread is executing instructions from the memory location by: (1) determining whether a first instruction to be executed by the thread is an instruction used for launching processes in a runtime environment; and (2) determining that the thread is executing instructions from the memory location when the first instruction to be executed by the thread is not an instruction used for launching processes in a runtime environment. The system may be configured to determine whether the first instruction to be executed by the thread is an instruction for launching processes in a runtime environment by: (1) identifying the first instruction; and (2) determining whether the first instruction is used for launching processes in a runtime environment (e.g., an instruction associated with the _RtlUserThreadStart function, or another function for launching processes in a runtime environment). In some embodiments, the system may be configured to identify the first instruction using an API function. For example, the system may determine the first instruction to be a parameter value obtained from the execution of a function (e.g., CreateThread, GetThreadContext, or another function). In some embodiments, the system may be configured to determine whether a thread is executing instructions from the memory location by disassembling the instructions to be executed by the thread and determining whether they are instructions from the memory location.

Next, process 300 proceeds to block 306, where the system identifies values of one or more visibility characteristics of the process that indicate whether the process is attempting to evade detection. Example visibility characteristics are described herein. In some embodiments, the system may be configured to identify value(s) of the visibility characteristic(s) by analyzing the process. For example, the system may access files associated with the process to determine the value of a visibility characteristic. As another example, the system may use information obtained about the identified memory location(s) and/or threads initialized therefrom to determine a value of a visibility characteristic.

Next, process 300 proceeds to block 308, where the system determines whether the process is a malware process based on the number of threads initialized by the process using the identified memory location(s) and the value(s) of the visibility characteristic(s). For example, the system may determine whether the process is a malware process by: (1) determining a number of the visibility characteristic(s) it has that indicate that the process is attempting to evade detection; and (2) determining whether the process is a malware process based on the number of the visibility characteristic(s) that indicate that the process is attempting to evade detection. As another example, the system may determine whether the process is a malware process by: (1) determining whether a subset of the visibility characteristic(s) have a value indicating that the process is attempting to evade detection; and (2) determining whether the process is a malware process when all the subset of the visibility characteristic(s) indicates that the process is attempting to evade detection.

In some embodiments, the system may be configured to identify the value(s) of the visibility characteristic(s) when a threshold number of threads (e.g., 5 threads) are identified as initializing from one of the memory location(s) being monitored. The system may be configured to trigger identification of the value(s) of the visibility characteristic(s) when the threshold number of threads is identified as initializing from one of the memory location(s) being monitored. If none of the memory location(s) is used to initialize the threshold number of threads, the system may bypass identification of value(s) of visibility characteristic(s) for the process (and thus determine that the process is not a malware process).

In some embodiments, the system may be configured to perform additional processing if the process is determined to be a malware process. For example, the system may terminate the process, perform additional monitoring (e.g., to collect more information about the process), contain the process in a sandbox environment (e.g., to further monitor the process), or perform other additional monitoring. In some embodiments, the system may be configured to track data manipulation (e.g., file changes) performed by the process and reverse the data manipulation when it is determined that the process is a malware process.

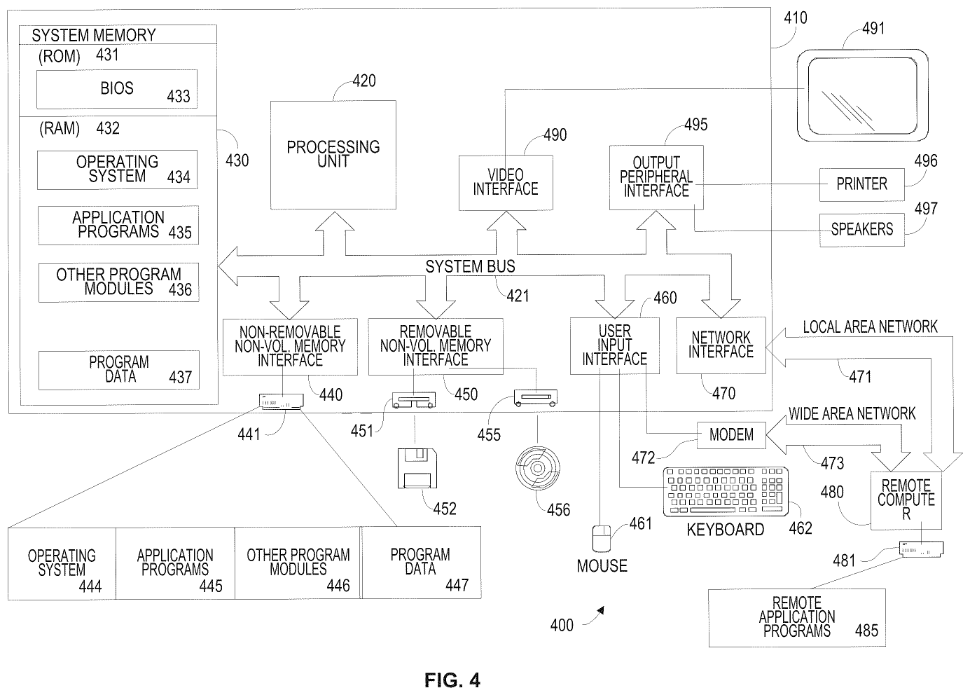

FIG. 4 shows a block diagram of an exemplary computing device, in accordance with some embodiments of the technology described herein. The computing system environment 400 is only one example of a suitable computing environment and is not intended to suggest any limitation as to the scope of use or functionality of the technology described herein.

The technology described herein is operational with numerous other general purpose or special purpose computing system environments or configurations. Examples of well-known computing systems, environments, and/or configurations that may be suitable for use with the technology described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The technology described herein may also be practiced in distributed computing environments where tasks are performed by remote processing devices that are linked through a communications network. In a distributed computing environment, program modules may be located in both local and remote computer storage media including memory storage devices.

With reference to FIG. 4, an exemplary system for implementing the technology described herein includes a general purpose computing device in the form of a computer 410. Components of computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bas.

Computer 410 typically includes a variety of computer readable media. Computer readable media can be any available media that can be accessed by computer 410 and includes both volatile and nonvolatile media, removable and non-removable media. By way of example, and not limitation, computer readable media may comprise computer storage media and communication media. Computer storage media includes volatile and nonvolatile, removable, and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 410. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation. FIG. 4 illustrates operating system 434, application programs 435, other program modules 436, and program data 437.

The computer 410 may also include other removable/non-removable, volatile or nonvolatile computer storage media. By way of example only, FIG. 4 illustrates a hard disk drive 441 that reads from or writes to non-removable, nonvolatile magnetic media, a flash drive 451 that reads from or writes to a removable, nonvolatile memory 452 such as flash memory, and an optical disk drive 455 that reads from or writes to a removable, nonvolatile optical disk 456 such as a CD ROM or other optical media, Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440, and magnetic disk drive 451 and optical disk drive 455 are typically connected to the system bus 421 by a removable memory interface, such as interface 450.

The drives and their associated computer storage media described above and illustrated in FIG. 4, provide storage of computer readable instructions, data structures, program modules and other data for the computer 410. In FIG. 4, for example, hard disk drive 441 is illustrated as storing operating system 444, application programs 445, other program modules 446, and program data 447. Note that these components can either be the same as or different from operating system 434, application programs 435, other program modules 436, and program data 437. Operating system 444, application programs 445, other program modules 446, and program data 447 are given different numbers here to illustrate that, at a minimum, they are different copies. An actor may enter commands and information into the computer 410 through input devices such as a keyboard 462 and pointing device 461, commonly referred to as a mouse, trackball, or touch pad. Other input devices (not shown) may include a microphone, joystick, game pad, satellite dish, scanner, or the like. These and other input devices are often connected to the processing unit 420 through a user input interface 460 that is coupled to the system bus, but may be connected by other interface and bus structures, such as a parallel port, game port or a universal serial bus (USB). A monitor 491 or other type of display device is also connected to the system bus 421 via an interface, such as a video interface 490. In addition to the monitor, computers may also include other peripheral output devices such as speakers 497 and printer 496, which may be connected through an output peripheral interface 495.

The computer 410 may operate in a networked environment using logical connections to one or more remote computers, such as a remote computer 480. The remote computer 480 may be a personal computer, a server, a router, a network PC, a peer device, or other common network node, and typically includes many or all of the elements described above relative to the computer 410, although only a memory storage device 481 has been illustrated in FIG. 4. The logical connections depicted in FIG. 4 include a local area network (LAN) 471 and a wide area network (WAN) 473, but may also include other networks. Such networking environments are commonplace in offices, enterprise-wide computer networks, intranets, and the Internet.

When used in a LAN networking environment, the computer 410 is connected to the LAN 471 through a network interface or adapter 470. When used in a WAN networking environment, the computer 410 typically includes a modem 472 or other means for establishing communications over the WAN 473, such as the Internet. The modem 472, which may be internal or external. may be connected to the system bus 421 via the actor input interface 460, or other appropriate mechanism. In a networked environment, program modules depicted relative to the computer 410, or portions thereof, may be stored in the remote memory storage device. By way of example, and not limitation, FIG. 4 illustrates remote application programs 485 as residing on memory device 481. It will be appreciated that the network connections shown are exemplary and other means of establishing a communications link between the computers may be used.

Having thus described several aspects of at least one embodiment of the technology described herein, it is to be appreciated that various alterations, modifications, and improvements will readily occur to those skilled in the art. Such alterations, modifications, and improvements are intended to be part of this disclosure, and are intended to be within the spirit and scope of disclosure. Further, though advantages of the technology described herein are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

The above-described embodiments of the technology described herein can be implemented in any of numerous ways. For example, the embodiments may be implemented using hardware, software, or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. However, a processor may be implemented using circuitry in any suitable format.

Further, it should be appreciated that a computer may be embodied in any of a number of forms, such as a rack-mounted computer, a desktop computer, a laptop computer, a tablet computer, a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, aspects of the technology described herein may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments described above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the technology as described above. A computer-readable storage medium includes any computer memory configured to store software, for example, the memory of any computing device such as a smart phone, a laptop, a desktop, a rack-mounted computer, or a server (e.g., a server storing software distributed by downloading over a network, such as an app store)). As used herein, the term “computer-readable storage medium” encompasses only a non-transitory computer-readable medium that can be considered to be a manufacture (i.e., article of manufacture) or a machine. Alternatively, or additionally, aspects of the technology described herein may be embodied as a computer readable medium other than a computer-readable storage medium, such as a propagating signal.

The terms “program” or “software” are used herein in a generic sense to refer to any type of computer code or set of processor-executable instructions that can be employed to program a computer or other processor to implement various aspects of the technology as described above. Additionally, it should be appreciated that according to one aspect of this embodiment, one or more computer programs that when executed perform methods of the technology described herein need not reside on a single computer or processor, but may be distributed in a modular fashion among a number of different computers or processors to implement various aspects of the technology described herein.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the technology described herein may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the technology described herein may be embodied as a method, of which examples are provided herein including with reference to FIGS. 6 and 7. The acts performed as part of any of the methods may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an.” as used herein in the specification and in the claims. unless clearly indicated to the contrary, should be understood to mean “at least one.”

The phrase “and/or,” as used herein in the specification and in the claims. should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A-only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B.” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A method for detecting presence of malicious software in a computing asset that is part of a computing environment, the method comprising:
using one or more processors to perform:
identifying, from among a plurality of memory locations allocated for use by a process managed by an operating system (OS) associated with the computing asset, at least one memory location to monitor in furtherance of detecting presence of malicious software in the computing asset;
monitoring threads initialized by the process using the at least one identified memory location to determine a number of threads so initialized;
identifying one or more values for one or more visibility characteristics of the process, each visibility characteristic value being indicative of whether the process is attempting to evade detection of its execution on the computing asset; and
determining whether the process is a malicious software process based on the number of threads and the one or more values for the one or more visibility characteristics.

2. The method of claim 1, further comprising:
triggering monitoring of threads initialized by the process using the at least one identified memory location in response to identifying the at least one memory location to monitor in furtherance of detecting presence of malicious software in the computing asset.

3. The method of claim 1, wherein identifying, from among the plurality of memory locations allocated for use by the process managed by the operating system (OS) associated with the computing asset, the at least one memory location to monitor in furtherance of detecting presence of malicious software in the computing asset comprises:
determining that data stored in and/or associated with the at least one memory location was modified during runtime of the process; and
identifying the at least one memory location to monitor in furtherance of detecting presence of malicious software in the computing asset in response to determining that the at least one memory location was modified during execution of the process.

4. The method of claim 1, further comprising, after initialization of the process, monitoring memory locations allocated by the OS to identify the plurality of memory locations allocated for use by the process.

5. The method of claim 1, wherein monitoring the threads initialized by the process using the at least one memory location to determine the number of threads so initialized comprises:
determining whether a first instruction to be executed by a thread is an instruction from the at least one memory location; and
determining that the thread is initialized by the process when it is determined that the first instruction to be executed by the thread is an instruction from the at least one memory location,

6. The method of claim 5. wherein determining whether the first instruction to be executed by the thread is an instruction from the at least one memory location comprises:
determining whether the first instruction to be executed by the initialized thread is an instruction used for launching processes in a runtime environment; and
determining that the first instruction to be executed by the initialized thread is an instruction from the at least one memory location when it is determined that the first instruction to be executed by the initialized thread is not an instruction used for launching processes in a runtime environment.

7. The method of claim 1, wherein identifying the one or more values for the one or more visibility characteristics for the process comprises:
determining that the number of threads initialized by the process using the at least one memory location meets or exceeds a threshold number of threads; and
identifying the one or more values for the one or more visibility characteristics in response to determining that the number of threads initialized by the process using the at least one memory location meets or exceeds the threshold number of threads.

8. The method of claim 1, wherein the one or more visibility characteristics comprise at least one of:
a graphical user interface (GUI) characteristic indicating whether the process is associated with a GUI:
a signature characteristic indicating whether the process is signed with an invalid signature:
a location access characteristic indicating whether the process accesses one or more particular data locations of the computing asset;
an installation characteristic indicating whether data accessed by the process was installed on the computing asset using an installation application associated with the OS; and
a module characteristic of a module used by the process to initiate at least one of the threads.

9. The method of claim 1, further comprising:
terminating the process when it is determined that the process is a malicious software process based on the number of threads and the one or more values for the one or more visibility characteristics.

10. The method of claim 1, further comprising:
generating an alert in a graphical user interface (GUI) of a software application when it is determined that the process is a malicious software process based on the number of threads and the one or more values for the one or more visibility characteristics.

11. The method of claim 1, further comprising:
tracking data manipulation performed by the process; and
reversing the data manipulation performed by the process when it is determined that the process is a malicious software process based on the number of threads and the one or more values for the one or more visibility characteristics.

12. A non-transitory computer-readable storage medium storing instructions that, when executed by one or more processors, causes the one or processors to perform a method for detecting presence of malicious software in a computing asset that is part of a computing environment, the method comprising:
identifying, from among a plurality of memory locations allocated for use by a process managed by an operating system (OS) associated with the computing asset, at least one memory location to monitor in furtherance of detecting presence of malicious software in the computing asset;
monitoring threads initialized by the process using the at least one identified memory location to determine a number of threads so initialized;
identifying one or more values for one or more visibility characteristics of the process, each visibility characteristic value being indicative of whether the process is attempting to evade detection of its execution on the computing asset; and
determining whether the process is a malicious software process based on the number of threads and the one or more values for the one or more visibility characteristics.

13. The non-transitory computer-readable medium of claim 12, wherein the method further comprises:
triggering monitoring of threads initialized by the process using the at least one identified memory location in response to identifying the at least one memory location to monitor in furtherance of detecting presence of malicious software in the computing asset.

14. The non-transitory computer-readable medium of claim 12, wherein identifying, from among the plurality of memory locations allocated for use by the process managed by an operating system (OS) associated with the computing asset, the at least one memory location to monitor in furtherance of detecting presence of malicious software in the computing asset comprises:
determining that data stored in and/or associated with the at least one memory location was modified during runtime of the process; and
identifying the at least one memory location to monitor in furtherance of detecting presence of malicious software in the computing asset in response to determining that the at least one memory location was modified during execution of the process.

15. The non-transitory computer-readable medium of claim 12, wherein the method further comprises:
after initialization of the process, monitoring memory locations allocated by the OS to identify the plurality of memory locations allocated for use by the process.

16. The non-transitory computer-readable medium of claim 12, wherein monitoring threads initialized by the process using the at least one memory location to determine the number of threads so initialized comprises:
determining whether a first instruction to be executed by a thread is an instruction from the at least one memory location; and
determining that the thread is initialized by the process when it is determined that the first instruction to be executed by the thread is an instruction from the at least one memory location.

17. The non-transitory computer-readable medium of claim 12, wherein identifying the one or more values for the one or more visibility characteristics for the process comprises:
determining that the number of threads initialized by the process using the at least one memory location meets or exceeds a threshold number of threads; and
identifying the one or more values for the one or more visibility characteristics in response to determining that the number of threads initialized by the process using the at least one memory location meets or exceeds the threshold number of threads.

18. The non-transitory computer-readable medium of claim 12, wherein identifying the one or more values for the one or more visibility characteristics for the process comprises:
determining that the number of threads initialized by the process using the at least one memory location meets or exceeds a threshold number of threads; and
identifying the one or more values for the one or more visibility characteristics in response to determining that the number of threads initialized by the process using the at least one memory location meets or exceeds the threshold number of threads.

19. The non-transitory computer-readable medium of claim 12, wherein the one or more visibility characteristics comprise at least one of:
a graphical user interface (GUI) characteristic indicating whether the process is associated with a GUI;
a signature characteristic indicating whether the process is signed with an invalid signature;
a location access characteristic indicating whether the process accesses one or more particular data locations of the computing asset; and
an installation characteristic indicating whether data accessed by the process was installed on the computing asset using an installation application associated with the OS.

20. A system for detecting presence of malicious software in a computing asset that is part of a computing environment, the system comprising:
at least one processor; and
at least one non-transitory computer-readable storage medium storing instructions that, when executed by the at least one processor, cause the at least one processor to perform:
identifying, from among a plurality of memory locations allocated for use by a process managed by an operating system (OS) associated with the computing asset, at least one memory location to monitor in furtherance of detecting presence of malicious software in the computing asset;
monitoring threads initialized by the process using the at least one identified memory location to determine a number of threads so initialized;
identifying one or more values for one or more visibility characteristics of the process, each visibility characteristic value being indicative of whether the process is attempting to evade detection of its execution on the computing asset; and
determining whether the process is a malicious software process based on the number of threads and the one or more values for the one or more visibility characteristics.
